(19) United States
(12) Patent Application Publication
(10) Pub. No.: US 2006/0116207 A1
(43) Pub. Date: Jun. 1, 2006

(54) ELECTRONIC GAMING SYSTEM

(75) Inventor: Tony DeLeon, Lakeside, CA (US)

Correspondence Address: IRELL & MANELLA LLP, 1800 AVENUE OF THE STARS, SUITE 900, LOS ANGELES, CA, 90067, US

(73) Assignee: BARONA TRIBAL GAMING AUTHORITY, Lakeside, CA (US)

(21) Appl. No.: 10/908,435

(22) Filed: May 11, 2005

Related U.S. Application Data
(60) Provisional application No. 60/631,817, filed on Nov. 29, 2004.

(51) Int. Cl. G06F 19/00; G06F 17/00

(52) U.S. Cl. 463/42

(57) ABSTRACT

An electronic gaming machine system comprises a plurality of electronic gaming machines interconnected in a network configuration, to a central gaming system computer for monitoring the electronic gaming machines, and a plurality of player interface modules physically proximate to the electronic gaming machines. The player interface modules are communicatively coupled to a central player system computer and communicate according to a protocol other than the gaming machine protocol. The player interface modules may include a display and data entry device, such as a touchscreen, and allow two-way interactive communication with an operator or another patron.

### RELATED APPLICATION INFORMATION

This application claims priority to U.S. Provisional Application Ser. No. 60/631,817 filed Nov. 29, 2004, hereby incorporated by reference as if set forth fully herein.

### BACKGROUND OF THE INVENTION

1. Field of the Invention

The field of the invention generally pertains to electronic gaming machines and, more particularly, to apparatus and methods for providing extended interactive features for use in conjunction with electronic gaming machines in a gaming network.

2. Background

Gaming establishments often provide a large number of electronic gaming machines connected to and controlled by a central computer, which serves as the host for a local area network. The central computer may provide the ability to extract certain accounting data from the electronic gaming machines, monitor usage and payout, and track player activity. Electronic gaming machines are typically configured with microprocessor-based intelligence for handling gaming functions and, where needed, for handling communication with the central computer or network that manages the gaming machines.

Conventional networks of gaming machines may suffer from various drawbacks of limitations. For example, gaming establishments are limited by the protocols and capabilities supplied by the gaming machine vendors. If an electronic gaming machine does not have a particular capability or feature, the gaming establishment generally cannot provide that capability or feature to its customers. Similarly, large gaming establishments may utilize gaming machines from a variety of different vendors. The gaming machines from different vendors may have incompatible protocols, or else have a different set of capabilities and features. Thus, not all features and capabilities will be uniformly available across all of the establishment's gaming machines. In addition, coordination of similar features across different gaming machines may be burdensome and inconvenient.

Conventional gaming machines also limit the type and nature of customization that a gaming establishment may want to develop or deploy. Moreover, typical gaming machine networks do not generally provide features which take advantage of, or are related to, the physical deployment of the gaming machines.

One particular limitation of conventional gaming machine systems is that bonusing is integrated with the central computer network. Such a configuration limits the flexibility of a gaming establishment, and may, for example, make it difficult to implement a common bonusing scheme across gaming machines from different vendors.

It would be advantageous to provide an apparatus or method that overcomes one or more of the aforementioned drawbacks or limitations, and/or provides additional capabilities and advantages.

### SUMMARY OF THE INVENTION

In one aspect, an electronic gaming machine system comprises a plurality of electronic gaming machines interconnected in a network configuration, to a central gaming system computer for monitoring the electronic gaming machines and communicating therewith according to a gaming machine protocol. The gaming machine system further may comprise a plurality of player interface modules physically proximate to the electronic gaming machines, the player interface modules being communicatively coupled to a central player system computer and communicating therewith according to a protocol other than the gaming machine protocol.

In another aspect, a player interface module is adapted for use with an electronic gaming machine. The player interface module is preferably located physically proximate to the electronic gaming machine, and includes a display and data entry device. A player interface module controller includes a communication interface for communicating with a central player system computer according to a protocol different from the gaming machine protocol, and preferably conveys user selections input via the data entry device to the central player system computer.

Further embodiments, variations and enhancements are also disclosed herein.

### BRIEF DESCRIPTION OF THE DRAWINGS

FIG. 1 is a conceptual diagram of an electronic gaming machine system in accordance with one or more embodiments as disclosed herein.

FIG. 2 is a diagram of an electronic gaming machine with a user interface module, as may be used, for example, in the gaming machine system of FIG. 1.

FIG. 3 is a diagram showing details of a particular electronic gaming machine system architecture, in general accordance with the principles of FIG. 1.

FIG. 4 is a process flow diagram illustrating functional processing for a player interface module in accordance with one example as disclosed herein.

FIG. 5 is a system diagram illustrating software or functional components of a player interface module management system in accordance with one example as disclosed herein.

### DETAILED DESCRIPTION OF PREFERRED EMBODIMENT(S)

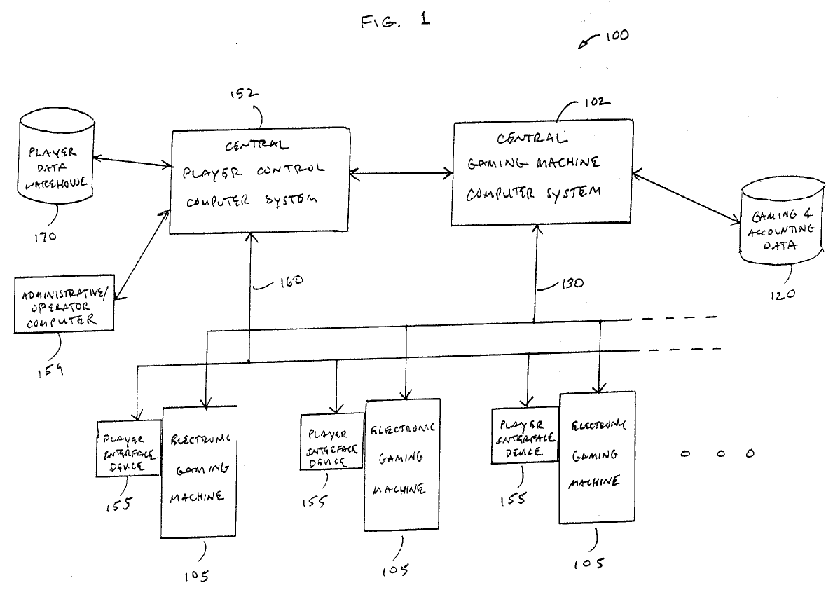

An electronic gaming system 100 in accordance with certain embodiments as disclosed herein is illustrated in FIG. 1. As shown therein, the gaming system 100 includes a number of electronic gaming machines 105 electronically connected to a central gaming machine computer system 102, which receives and stores on-going game transaction information according to protocols well known in the art of electronic gaming. While the electronic gaming machines 105 are shown as being connected by communication paths 130 to the central gaming machine computer system 102, it should be understood that the communication paths 130 may be wired or wireless in nature. The central gaming machine computer system 102 preferably comprises a gaming machine interface for communication with the electronic gaming machines 105. Communication between the central network computer system 102 and the various gaming machines 105 may be carried out using any standard (or non-standard) gaming device interface protocol, such as SAS or SDS, for example, both of which are conventional and well known in the field of gaming devices.

The central gaming machine computer system 102 of the electronic gaming system 100 in FIG. 1 is preferably configured to interact with, and control, the electronic gaming machines 105 according to conventional methodologies, with certain exceptions as are herein described. The central gaming machine computer system 102 may, for example, collect audit data from the various electronic gaming machines 105 and otherwise monitor their usage in a variety of manners as known in the art. The central gaming machine computer system 102 preferably includes a gaming machine database 120 or other similar repository for storing audit data and other information as needed. In one aspect, the central gaming machine computer system 102 may be viewed as being part of a gaming machine system network.

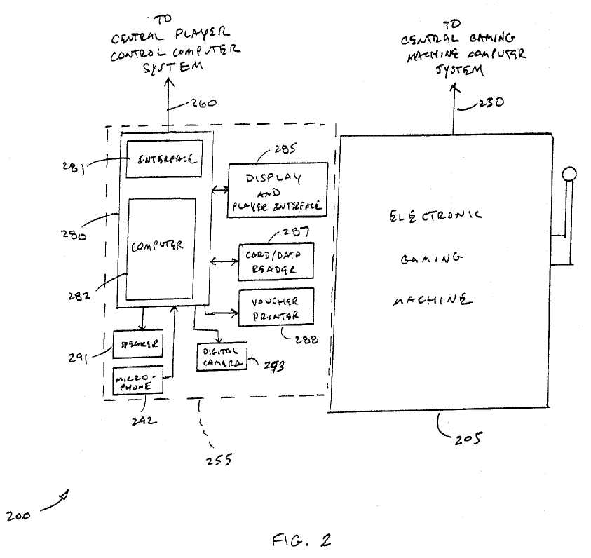

The electronic gaming system 100 in the example of FIG. 1 preferably includes, in parallel with the gaming machine system network, a player control network comprising a central player control computer system 152 which electronically communicates with a plurality of electronic player interface modules 155, preferably disposed at one or more of the electronic gaming machines 105. Further details concerning preferred configurations for the player interface modules 155 are described in connection with FIG. 2 and elsewhere herein. While the player interface modules 155 are shown as being connected by communication paths 160 to the central player control computer system 152, it should be understood that the communication paths 160 may be wired or wireless in nature. The central player control computer system 152 preferably comprises a player device communication interface for communicating with the player interface modules 155. Communication between the central player control computer system 152 and the various player interface modules 155 may be carried out using any standard communication protocol, such as TCP/IP, or alternatively a suitable custom protocol.

One characteristic of the electronic gaming system 100 of FIG. 1 is that the electronic gaming machines 105 may be from different vendors or companies, and may use different protocols. Indeed, the electronic gaming system 100 could support a number of different central gaming machine computer systems 102, each configured to operate with specific types of gaming machines, while a single central player control computer system 102 may be utilized to communicate with the player interface modules 155 regardless of which type of electronic gaming machine 105 they are located at.

The central player control computer system 152 of the electronic gaming system 100 of FIG. 1 is preferably configured to interact with, and to some extent control, the player interface modules 155, as herein described. The central player control computer system 152 may, for example, offer or provide player services from the gaming establishment, allow interactive player communication, provide customized bonusing schemes, and/or provide other features. The central player control computer system 152 may include a player database 170 (which may be a separate data warehouse system), for storing, e.g., player information and tracking data. The central player control computer system 152 may be configured to communicate with the central gaming machine computer system 102, and may have access (in real time) to player activity on the various electronic gaming machines 105, and/or to audit data stored in the gaming machine database 120.

The division of responsibility between the central player control computer system 152 and the player interface modules 155 is flexible, and depends to some extent on implementation choices, including the speed, capability, and sophistication of hardware and applications of the player interface modules 155. At one extreme, the central player control computer system 152 may perform the substantial share of player interface management, tracking individual player activity, managing instant bonusing functions, and processing player requests received from the player interface modules 155. In such a scenario, the player interface modules 155 may be treated more as “dumb” terminals having a primary function of inputting and outputting information to its various peripheral devices. At the other extreme, the player interface modules 155 may be highly independent, each running local versions of applications controlling the various interactive functions described later herein. In this scenario, the player interface modules 155 generally call upon the central player control computer system 152 when needing to send information to, or retrieve information from, a remote location. The division of responsibility and functionality between the central player control computer system 152 and player interface modules 155 may also be divided at some intermediate level. Thus, while the examples described herein may indicate that particular activities are carried out at the central player control computer system 152 or at the player interface modules 155, it should be understood that portions of those functions may be carried out with greater or lesser dependence on the central player control computer system 152 or player interface devices 155.

FIG. 2 is a diagram illustrating a particular example of a gaming machine unit 200 comprising an electronic gaming machine 205 with a player interface module 255, as may be used, for example, in the electronic gaming system 100 of FIG. 1, or in other system architectures as described herein. In FIG. 2, the electronic gaming machine 205 may be of any conventional or commercially available type, as generally described previously herein. The player interface module 255 in this example preferably includes a controller 280 which may comprise, e.g., a computer 282 (or equivalent in digital circuitry or hardware), connected to an interactive user interface 285 which may comprise, for example, a touchscreen display. The controller 280 is preferably configured to communicate with a central player control computer system (e.g., 152 in FIG. 1) via a network interface 281. The player interface module 255 may further include a portable data carrier reader 287 (such as a magnetic stripe reader and/or a smart card reader), as well as a printer device 288 for, e.g., printing vouchers for “cashless” gaming, coupons, promotional information, and the like. The optional portable data carrier reader 287 and printer 288 may be electronically coupled to, and under the control of, the controller 280.

The player interface module 255, and the interactive user interface 285 in particular, may be either physically mounted adjacent to the electronic gaming machine 205 or else embedded in the front display (e.g., in the belly glass) portion of the electronic gaming machine 205. The latter configuration may improve aesthetics but may also require some physical modification to the electronic gaming machine 205. Mounting the player interface module 255 to the electronic gaming machine 255 may be carried out using any conventional or appropriate means; for example, by affixing a projecting arm or strut from the side or top of the electronic gaming machine 205, or by using one or more L-joints physically attached to the back of the player interface module 255 and the side of the electronic gaming machine 205, or by any other mechanical means. In certain embodiments, the player interface module 255 may be positioned proximate to the electronic gaming machine 205 but not physically attached to it.

In a preferred embodiment, the interactive user interface 285 of the player interface module 255 comprises a touchscreen which displays information to a player at the electronic gaming machine 205, and, among other things, allows the player to make selections of various options relating to the gaming experience. Preferably, the controller 280 and its internals (including computer 282 and network interface 281) are physically compact in size and shape, and relatively low profile, to minimize their visual appearance. The digital electronics for the controller 280 may be conveniently disposed, for example, in or along the base of the player interactive user interface 285, or attached to the back surface thereof. The controller 280 may share a common housing with the interactive user interface 285 or they may have separate housings mechanically attached to one another.

The optional portable data carrier reader 287 and printer 288 may likewise be encased in a common housing with the controller 280 and/or interactive user interface 285, or else may have their own housing(s) physically attached to the controller 280 and/or interactive user interface 285.

Whether or not the player interface module 255 is physically integrated with the electronic gaming machine 205, its functions and hardware preferably remain separate from the electronic gaming machine 205. The electronic gaming machine 205 is preferably configured to communicate with a central gaming machine computer system (such as central gaming machine computer system 102 in FIG. 1) according to a gaming machine protocol, while the player interface module 255 is preferably configured to communicate with a central player control computer system (such as central player control computer system 152 in FIG. 1) according to a protocol different from the gaming machine protocol. The controller 280, and its internals including the computer 282 and network interface 281, preferably operate independently of the electronic gaming machine 205 and are not electronically connected to or under control of the electronic gaming machine 205. The player interface module 255 likewise does not interface directly with the central gaming machine computer system, although it may receive information therefrom via the central player control computer system, as further explained herein.

A benefit of the gaming machine unit 200 such as illustrated in FIG. 2 is that the player interface modules 255 are not limited by the capabilities, protocols, or functionality of the electronic gaming machine 205 and the central gaming machine computer system. Additional functionality and capabilities may be provided by the central player control computer system, independent of the type of electronic gaming machine. Player interface modules 255 may be located at electronic gaming machines 205 of different manufacturers, yet may present a similar graphical appearance and interactive experience to all players, although the presentation and particular content may be tailored based on the profile of the specific players.

The interactive player interface 285 may be embodied in various alternative manners. For example, the interactive player interface 285 may comprise a display screen with input keys, buttons, and/or a stylus. In a relatively simple and less versatile configuration, the interactive player interface 285 may alternatively comprise a set of LEDs with input keys or buttons. In conjunction with any of the embodiments, the player interface module 255 may also comprise one or more speakers 291 for audio output, as well as a microphone 292 for two-way audio communication. In addition, the player interface module 255 may comprise a digital camera 293 to allow, for example, an operator at a central player control computer system (e.g., 152 in FIG. 1) to observe patrons, or to allow patrons at different gaming machines to view one another assuming that communication between different player interface modules 255 is supported, as further described herein. In one aspect, the microphone 292, speaker(s) 291, and/or digital camera 293 may be viewed as part of the overall interactive player interface.

The player interface module 255 may provide a variety of capabilities and features for the gaming system. A number of these are described in more detail later herein. For example, the player interface module 255 may display games, advertising, and other information to patrons, and allow the selection of various presented options. The player interface module 255 is thus interactive in nature. It is also tied to a centralized data warehouse of player data, via the central player control computer system (e.g., 152 in FIG. 1), and allows the gaming establishment to interact with patrons and tailor the presentation of information at the player interface module 255 based upon information stored about the patrons in the data warehouse. This feature may allow the gaming establishment to offer the patron use of player points for certain purposes, and/or tailor particular offers or promotions to patrons based upon their profile or other information (such as length of play). The player interface module 255 may provide bonus opportunities using any of a variety of approaches, examples of which are further described herein. In addition, the player interface module 255 may allow communication, via an interactive player interface which may include one or more speakers 291 and microphone 292. The system may be configured to allow the patron to communicate interactively with an operator or administrator at the central player control computer system, and vice versa, and/or with other patrons at remote gaming machine units. The player interface module 255 is not limited to merely reading static information, monitoring player activity, or displaying information. Moreover, the player interface module 255 is not limited by the protocol, features, or capabilities of the electronic gaming machine 205.

Thus, in one aspect, a multi-functional player device is provided in the form of a player interface module 255, preferably functionally separate from the electronic gaming machine 205 but physically proximate thereto.

Returning to FIG. 1, the player database 170 may comprise a repository for storing profile information about gaming establishment patrons. The player database 170 may contain, for example, demographic information such as address, and event information such as date of birth, anniversary, etc. The player database 170 may also contain stated personal preference information, such as sport or hobby information (e.g., “enjoys golf”), preferences for certain foods or beverages, or gaming preferences (e.g., “likes to playbacks or Better video poker”). In addition, the player database 170 may contain historical gaming information, collected over time by the central player control computer system 152, or players club card tier status if the gaming establishment has a players club. The player database 170 may additionally contain information accumulated from the players' transactions with the gaming establishment and, in some cases, affiliated entities (e.g., entities which provide data to the gaming establishment). For example, the player database 170 may store data relating to transactions that the player may make involving restaurant, retail, golf, and hotel purchases, and revenue amounts, assuming these businesses are affiliated with the gaming establishment. The information in the player database 170 may be drawn upon to tailor the experience of the players, and/or provide features such as instant bonus opportunities, as further described herein.

In one aspect, the player database 170 may provide a cohesive collection of player information aggregated from a variety of different systems and sources, allowing the central player control computer system 152 to rapidly obtain player information in a known format, suitably processed and scrubbed. The player database 170 thus increases data integrity, and may allow, for example, a rules engine for generating instant bonus opportunities to have access to comprehensive, meaningful and accurate player data.

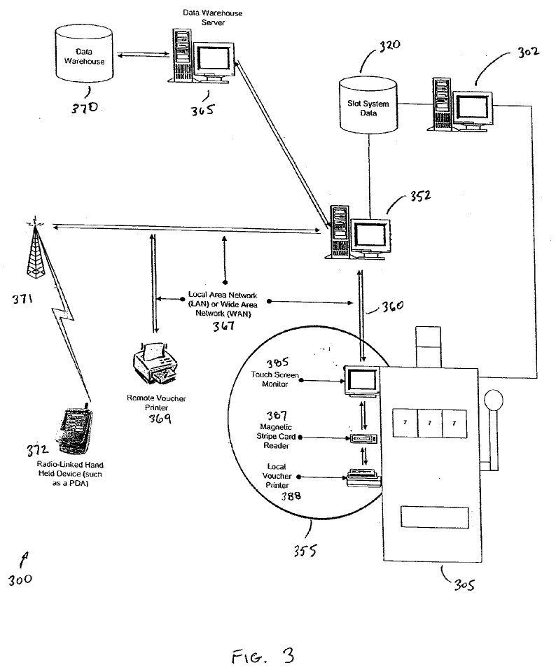

FIG. 3 is a diagram showing details of a particular electronic gaming machine system architecture, in general accordance with the principles of FIG. 1. In FIG. 3, only a single electronic gaming machine 305 and its associated player interface module 355 are illustrated in the system 300, but it is to be understood that any number of electronic gaming machines 305 and their associated player interface modules 355 may be supported. Similar to the system 100 of FIG. 1, the system 300 in FIG. 3 includes a central player control computer system 352 that is communicatively coupled to the player interface module(s) 355 in the system 300. A central gaming machine computer system 302 is communicatively coupled to the electronic gaming machine(s) 305 in the system 300. Gaming data, including accounting data, is stored in a gaming machine database 320 or other similar repository for storing audit data and other related information, and which is accessible to the central player control computer system 352 as needed. The central player control computer system 352 may, for example, determine if a certain electronic gaming machine 305 is in use by communicating with a server or other computer associated with the accounting database 320.

In the particular example illustrated in FIG. 3, the central player control computer system 352 forms part of a larger local area network (LAN) or wide area network (WAN) 367 that includes other system components such as a data warehouse serve 365, which manages the player data warehouse 370, remote voucher printers 369, and a wireless communication application and/or interface 371 which may permit communication with wireless portable computer devices 372 (such as personal digital assistants, or PDAs) over, e.g., a radio frequency (RF) link. The wireless communication link may allow, for example, an administrator or clerk at an administrator computer connected to the central player control computer system 352 to contact floor personnel to provide the specific requested services or items to the patron at the particular electronic gaming machine 305. The particular architecture illustrated in FIG. 3 may, certain environments, provide advantages of distributed control and inter-communication among different or remotely located system components, as well as a high degree of flexibility, expandability, and protocol independence. As one example, requests for service, promotion results, notifications, and so on, may be sent to any network-addressable device, such as printer, video display, pager, tablet computer, or wireless PDA.

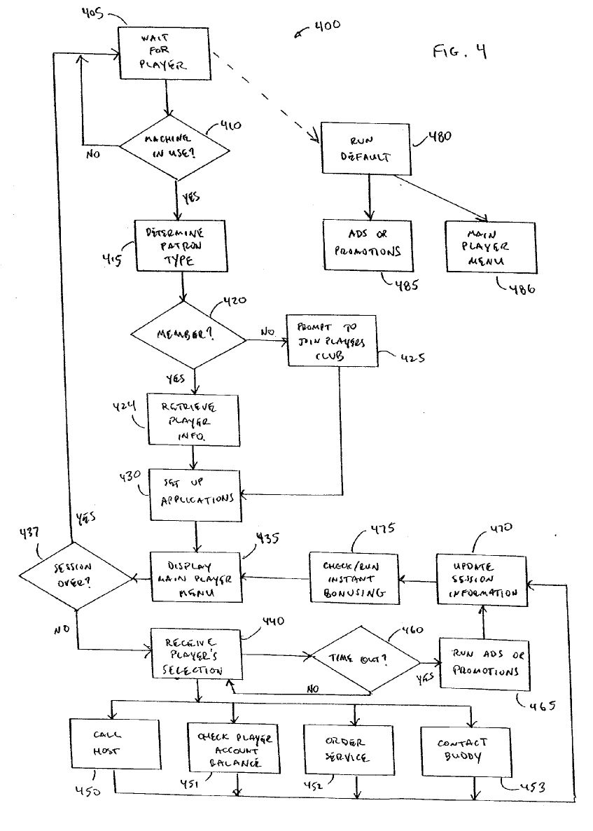

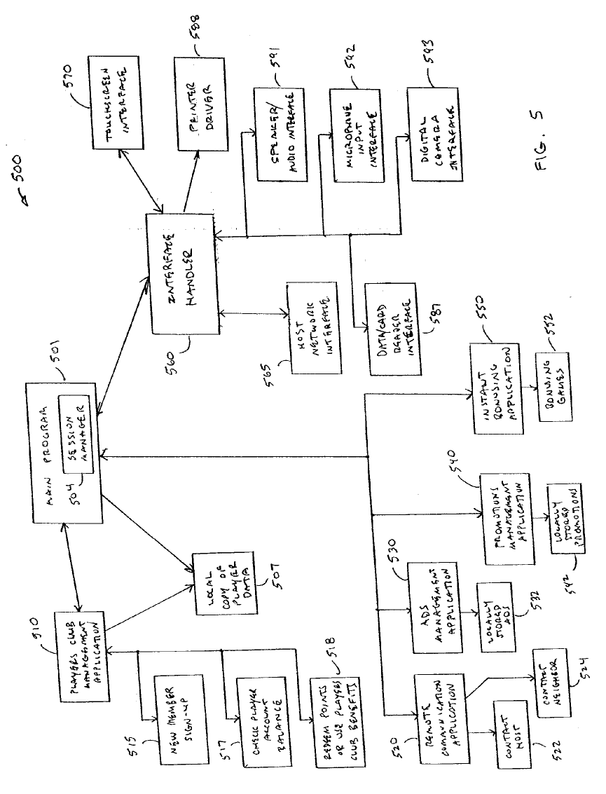

FIG. 5 illustrates software or functional components of one possible embodiment of a player interface module management system 500, in more detail. The player interface module management system 500 may be run, for example, by a controller 280 as shown in FIG. 2, or in a similar environment. The functional divisions implied by FIG. 5 are generally conceptual, and may be rearranged or combined in various aspects for a particular implementation without necessarily affecting the overall operation of the player interface module management system 500. Further details of the operation of the player interface module management system 500 are described later herein in connection with FIG. 4. With attention now to FIG. 5, the player interface module management system 500 may comprise a main program 501 having a session manager 504. The session manager 504 may have general responsibility for managing a session for a given player from start to finish. A local copy of player data 507 may be retrieved and stored under the control of the player interface module management system 500. If the patron is a member of the players club, for example, the player information might be retrieved from the player data warehouse (e.g., 170 in FIG. 1) via the central player control computer system (e.g., 152 in FIG. 1) or else may be read from the player's data carrier (such as a smart card or magnetic stripe card).

The player interface module management system 500 may further comprise an interface handler 560 for managing the various interfaces as may be required or provided by the player interface module. For example, the interface handler 560 may be capable of invoking a host network interface 565 for communicating with the host network (e.g., central player control computer system 152 of FIG. 1) according to the appropriate network protocol. The interface handler 560 may also be capable of invoking a touchscreen interface 570 for managing interactive communication with a touchscreen or, alternatively, other display and user input devices (e.g., collectively shown as interactive player interface 285 in FIG. 2). In addition, the interface handler 560 may be capable of invoking a data/card reader interface 587 for interacting with a card or data reader 287, a speaker or audio interface 591 for outputting audio data to one or more speakers 291, a microphone input interface 592 for receiving audio input from a microphone 292, a digital camera interface 593 for receiving image data from a digital camera 293, and a printer driver 588 for interfacing with a local printer 288 (for, e.g., printing vouchers). Other interface applications may also be provided depending upon the presence of other peripheral devices or hardware interfaces at the player interface module 255.

While it is convenient to illustrate an interface handler 560 to portray the variety of different interfaces that may be needed or provided at a player interface module, it will be understood that the various applications of the player interface module management system 500 may not require an interface handler 560, and may instead invoke any of the specific device interfaces (e.g., 565, 587, etc.) as needed to carry out their particular functions and actions.

The player interface module management system 500 may further include a players club management application 510, as illustrated in FIG. 5. The players club management application 510 may, for example, process new member sign-ups, account balance inquiries, and players club point redemption or use of club benefits via applications 515, 517 and 518, respectively. The players club management application 510 may provide any interaction that could normally be carried out online with respect to the players club, and may also trigger various ads or promotions specifically geared towards players club members. The players club management application may store and/or update the local copy of player data 507 if the patron signs up as a new member and inputs the required information for affiliating with the players club.

The player interface module management system 500 also may comprise a remote communication application 520, an ads management application 530, a promotions management application 540, and an instant bonusing application 550. The remote communication application 520 may, for example, handle communication via the host network, to allow the patron to contact a floor host or administrator when, e.g., requesting particular services, food/beverage items, cigars, cigarettes, and the like. The remote communication application 520 may also respond to communication requests from the host network. It may allow gaming establishment staff to send messages to the patron—for example, to congratulate the patron on winning a jackpot or instant bonus prize. The remote communication application 520 may also allow the patron to contact a neighbor or buddy at another electronic gaming machine, to the extent this feature is provided in the system. Applications 522 and 524, respectively, may be provided to handle the two aforementioned types of remote communication activities.

The ads management application 530 may handle the display of advertisements at the display of the player interface module, drawing upon either locally stored ads 532 or else receiving the ad content from the host network. The ads may be stored in any format suitable for playback at the player interface module. Likewise, a promotions management application 540 may handle the display and processing of promotions at the player interface module. The promotions management application 540 may draw upon either locally stored promotion information 542 or else receive the promotional information from the host network. To the extent that a promotion requires interaction with the patron (e.g., a selection by the patron of promotional offer, or input of information by the patron), the promotions management application 540 would generally handle that interaction as well.

The instant bonusing application 550 may handle instant bonus opportunities that arise due to any of a number of events or occurrences, as described in detail elsewhere herein. Depending upon the format of the bonus opportunity, the instant bonusing application 550 may draw upon various electronic games 552 stored locally. For example, the electronic games 552 may include draw poker or blackjack, if the bonus opportunity is dependent upon resolution of a game. The electronic games 552 may also include simple guessing games such as presentation of a number of images (e.g., moneybags or dollar signs), from which the patron can select. In certain embodiments, the bonusing application 550 may be delegated the task of monitoring the player's activity at the associated electronic gaming machine, and for triggering instant bonus opportunities when the patron has, e.g., played for a certain minimum amount of time or bet more than a certain minimum amount. Alternatively, these tasks may be performed locally by the main program 501 and/or session manager 504, or remotely by the host network. If instant bonus opportunities are triggered locally, a rules engine (not shown) may be provided to determine whether an instant bonusing opportunity should be provided.

FIG. 4 is a process flow diagram illustrating functional processing for a player interface module in accordance with one example as disclosed herein. The process 400 in FIG. 4 may be carried out, for example, using components such as illustrated in FIG. 5, or with other systems. In the present example, the process 400 will be described with respect to a player interface module 255 such as illustrated in FIG. 2; however, it should be understood that the process 400 will, in whole or part, be workable with other player interface module configurations as well.

In the process 400 shown in FIG. 4, during inactive periods while the electronic gaming machine is waiting for a player to arrive (step 405), the player interface module may be configured to perform a default routine 480, which, for example, may generally involve rotating among various animated attraction screens, advertising screens, and/or promotions, as indicated by step 485. The default routine 480 may also periodically display a player main menu 486, details of which are described later herein. In addition to running the default routine 480, the player interface module 255 may continuously poll to determine whether its associated electronic gaming machine is in use, as indicated by step 410. One way this may be done is for the player interface module 255 to poll the central player control computer system (e.g., 152 in FIG. 1) to determine whether the electronic gaming machine 205 it is associated with is in use and, if so, whether or not it is being used by a member of the gaming establishment players club. To facilitate this operation, the central player control computer system 152 may be in regular communication with the central gaming machine computer system 102 in order to obtain the identities (e.g., electronic gaming machine identification numbers) of the electronic gaming machines 105 currently in use, as well as, if possible, the identity of the patron and/or whether the patron is a players club member. The central player control computer system 152 passes this information along to the player interface modules (155 or 255) when polled. Alternatively, the central player control computer system 152 may electronically notify the appropriate player interface module 155 or 255 when its associated electronic gaming machine 105 or 205 is being utilized, by sending an appropriate message to the player interface module. The central player control computer system 152 may include a server application which monitors the central gaming machine computer system 102 and communicates with the various player interface modules.

When the player interface module 255 determines that its associated electronic gaming machine 205 is in use, its next actions may depend upon whether or not the player is a club member of the gaming establishment. It is common for gaming establishments to include a members club which provide various benefits to the members. The members are typically provided with a means of identification, such as a magnetic-stripe card. Often, electronic gaming machines are configured with card readers to allow members to present their membership card and notify the gaming system that a member is playing a particular machine. The gaming system may track the player's aggregate wagers and machine usage, and provide various benefits based thereon. As indicated by step 415, the player interface module 255 preferably determines whether the player at its associated electronic gaming machine 205 is a club member of the gaming establishment.

The player interface module 255 may determine that a club member is playing at its associated electronic gaming machine 205 in several different ways. For example, the central player control computer system 152 may obtain this information from the central gaming machine computer system 102 at the same time it polls to find out which gaming machines are in use. Alternatively, the player interface module 255 may be provided with its own data carrier reader (for example, a card reader) 287, such as shown in FIG. 2. The interactive player interface 285 may alternatively display a message prompting the player to present a members card to the data carrier reader 287, and may assume that the player is not a member is play proceeds without a members card being presented. If the player is club member, the player interface module may display a welcome message to the player along with, in some embodiments, the player's first name.

If the player is not a club member, the player interface module 255 may be configured to allow the player to join as a member, as indicated by step 425 in FIG. 4. To this end, the player interface module 255 may be configured to display (via the interactive player interface 285) information concerning the gaming establishment and the benefits of becoming a club member. The player interface module 255 may then display a message asking the patron if he or she would like to join the members club. If the patron responds favorably (e.g., using the touchscreen or other user input mechanism at the interactive player interface 285), the message may be relayed to the central player control computer system 152, which may in turn convey the message to the administrative gaming establishment computer 155. In response, the gaming establishment may dispatch a floor host to the gaming machine to enroll the player in the members club. Alternatively, the central player control computer system 152 may directly signal a floor host carrying a wireless handheld computer with a message that a patron is seeking to join the members club, and may also convey the electronic gaming machine identifier to the wireless handheld computer to allow ready identification of the machine and/or its location. Additionally, the data carrier reader 287 may be used to read the patron's drivers license and automatically enroll him or her in the members club using the information read therefrom. In alternative embodiments, step 425 may be bypassed.

If, on the other hand, the player is already a club member, the player interface module 255 may be configured to retrieve the player's profile or other information from the central player control computer system 152, as indicated by step 424 in FIG. 4. Such information may include, as previously indicated, the player's demographic information (such as address), special event information (such as date of birth, anniversary, etc.), personal preference information (including hobbies, food, drinks, games, etc.), players club card tier status, and the like. Whether or not the player is a member of the players club, or chooses to join, the process 400 proceeds to step 430, wherein various applications are set up based upon, if appropriate, the player's profile information or lack thereof. For example, the instant bonusing application (e.g., 550 in FIG. 5) may be invoked to detect whether the player's profile information should result in an instant bonus opportunity, based on criteria such as described later herein.

After any needed applications are set up, the process 400 moves to step 435, whereupon the main player menu is displayed on the display of the player interface module associated with the electronic gaming machine. The main player menu may present a variety of choices from which the patron may select—for example: (1) call host, (2) check player account balance (if the player is a member of the players club), (3) order service, or (4) contact buddy (if this capability is provided in the system). The menu display function awaits a selection by the patron, as indicated by step 440. However, if the session is terminated (as may be indicated in some configurations by the player removing his or her card/data carrier, or by inactivity at the associated electronic gaming machine for a certain time period), then, as indicated by step 437, the process 400 may return to a waiting cycle in step 405 until the next player arrives. When the patron removes his/her players club card or otherwise ends a session, the player interface module may be configured to display the patron's first name and a message thanking the patron for playing.

If a player selection is not received within a given period of time, as indicated by step 460, the process 400 may then proceed to run other applications, periodically re-displaying the menu selections. For example, the process 400 may proceed to step 465, wherein the player interface module management application may invoke applications for running ads or promotions. The ads or promotions may be rotated from among a variety of available ads or promotions, or may be selected in any desired manner. However, the ads and promotion screens preferably have a button, icon or other means for returning to the main player menu. Rules may be created to initiate or expire ads or promotions by date, day or time of day. The ads or promotions may, among other things, present information demonstrating the benefits of the players club, or next tier of the players club (which can be determined based on the player's current club membership status as retrieved from the player database 170, for example). A rule may be created to determine if the patron is on track to be uptiered, based upon his/her current play activity, and targeted marketing may be used to influence the patron to sustain or increase the level of play. The ads or promotions may also indicate to players what bypes of amenities or services can be redeemed with the number of club player points that the particular player has accumulated. Also, if the player has redeemed points in the past for a particular type of amenity or service, that same amenity or service, or a related one, may be presented on the display. With respect to promotions, players may check in for promotions via the player interface modules, and winners may be instantly notified through the same medium. In addition, a patron's response to promotions may be immediately recorded and stored in the player database 170, for future use.

The process 400 may be configured to periodically update the player's session information, as indicated by step 470, and also to check for instant bonus opportunities based upon length of play, amount won/lost, amount bet, and the like, as indicated by step 475. The session information may be updated by contacting the host network, which in turn may receive the desired information from the central gaming machine computer system (e.g., 102 in FIG. 1).

If a selection is received from the player (step 440) in response to the display of the main player menu (step 435), then the process 400 may invoke an appropriate routine or application to handle the request. For example, the process 400 may proceed to step 450 to contact floor personnel or otherwise reach an administrator, in response to the player's request for assistance. The process 400 may proceed to step 451 if the player desires to check his or her account balance at the players club. Similar process steps may be provided for other interactions with the players club system—for example, checking status information, updating personal profile information such as preferences or address, and the like. If the player is not a club member, then in step 451 an offer may be displayed encouraging the member to enroll in the players club. If the player accepts, a floor host may be dispatched to the gaming machine, or else the player may be enrolled using automated, interactive screens (e.g., as described with respect to step 425).

The process 400 may proceed to step 452 if the player desires to order service, such as food, beverages, merchandise, and so on. Step 452 may include the provision of one or more menu screens through which the player may navigate interactively, in order to make the desired selections. In some embodiments, the system may allow the player to use credit to purchase the food or sundry items by, e.g., charging them to an affiliated hotel room, using players club points, and so on. A request for order service may cause a receipt to print up at a service station indicating the patron's machine number and name (if available), and a server may be dispatched to receive the patron's order and/or deliver the requested items.

The process 400 may proceed to step 453 if the patron desires to contact a buddy or player at another local electronic gaming machine. Step 453 may require that the patron enter in sufficient identifying information, such as the other player's name, member number (if applicable), a gaming machine identifier, or other information suitable to locate the other player. The first player interface module may then communicate with the other player's player interface module, via the central player control computer network (e.g., 152 in FIG. 1). The system may provide for simple text messaging, or more elaborate communication, such as audio and/or visual communication provided using the speaker 291, microphone 292, digital camera 293 and display 285 at each of the player interface modules. Such communication options—i.e., text, audio and/or visual—are also possible when the patron is communicating with an administrator, floor personnel, and/or clerks (such as in steps 450 and 452).

As previously indicated, a variety of bonusing techniques may be provided in the various systems disclosed herein, and may be particularly well suited for the system architectures such as illustrated in FIGS. 1 or 3, for example.

Portions of the functionality of the bonusing application may be distributed at the player interface modules, and rules and parameters stored in or downloaded to the player interface modules; or alternatively, the central player control computer system could determine and handle the bonusing opportunities, with the player interface modules more or less providing input and output functions; or some mixture of responsibility may be provided. Among the different types of bonusing that may be provided are random, interactive, or play based (e.g., based on time play or amount won/lost/bet).

In a preferred embodiment, patrons using a players club card affiliated with the gaming establishment may be given the opportunity to win certain types of instant bonuses. Examples of bonus prizes may include instant cash or credits for gaming play, players club points, promotional items, discounts (at, e.g., stores, hotels, restaurants, etc.), or free amenities (such as food and beverage, hotel, golf, merchandise, etc.).

Rules may be created, and installed at the central player control computer system (e.g., 152 in FIG. 1) and/or distributed at the individual player interface modules, to allow instant bonusing opportunities based on any of a wide variety of criteria or events, including, for example, any of the following:

Patron's birthday, anniversary, or other special date: The bonusing application may compare the current date with the patron's profile information stored in, e.g., the player database (such as database 170 of FIG. 1 for example) or, if applicable, stored on the patron's gaming card. The application may be configured to provide an instant bonusing opportunity if the current date is an exact match with the relevant date information in the player's profile, or alternatively if the current date is within a certain range (e.g., two days) of the relevant date information in the player's profile.

Date, day, or time of day match: The bonusing application may compare the current date, day, or time of day against a predetermined or randomly generated date, day, or time of day, and generate an instant bonus opportunity if there is a match (or a match within a given range).

Maximum bet: The bonusing application may generate an instant bonus opportunity if the amount wagered is the maximum allowed, or exceeds a certain threshold. The bonusing application may receive this information from the central gaming machine computer system (e.g., 102 in FIG. 1), via the central player control computer system (e.g., 152 in FIG. 1).

Tier: The bonusing application generate an instant bonus opportunity if the patron has reached a specified tier in the players club. Such information may be available, e.g., via the player database (e.g., 170 in FIG. 1) or otherwise through the gaming establishment players club system.

Club number: The bonusing application may compare the patron's membership or club number, or a portion thereof, with a preselected or randomly generated number (or set of numbers). The application may be configured to provide an instant bonusing opportunity if there is a numerical match.

Jackpot hit on associated gaming machine: The bonusing application may be configured to provide an instant bonusing opportunity if any of a selected group of gaming machines associated with the patron's gaming machine scores a jackpot hit.

Gaming time exceeds certain amount (e.g., coin in over X minutes): The bonusing application may keep track of the duration of the patron's gaming session and compare the duration with a preselected duration. The application may be configured to provide an instant bonusing opportunity if the duration of the gaming session exceeds the preselected duration. Additional bonusing opportunities may be provided as the patron continues to play; these subsequent opportunities may be offered after the elapse of the same preselected duration, or other shorter or longer durations.

Actual win or loss amount: The bonusing application may keep track of, or acquire information concerning, actual win or loss amounts accrued during the patron's gaming session, or over the course of a number of gaming sessions within a specified period. For example, the bonusing application may receive information concerning the actual win/loss amount for the patron's gaming session from the central player control computer system (e.g., 152 in FIG. 1), via the central gaming machine computer system (e.g., 102 in FIG. 1). The application may be configured to provide an instant bonusing opportunity if the win or loss amount exceeds the preselected amount. Additional bonusing opportunities may be provided as the patron continues to play; these subsequent opportunities may be offered after the patron exceeds the same preselected amount, or other smaller or larger amounts.

Number of visits within certain time period: The bonusing application may keep track of, or acquire information concerning, the number of gaming sessions played by a patron over a certain time period. For example, the bonusing application may receive information concerning the number of gaming sessions from the central player control computer system (e.g., 152 in FIG. 1), via the central gaming machine computer system (e.g., 102 in FIG. 1). The application may be configured to provide an instant bonusing opportunity if the number of gaming sessions in a given time period exceeds a preselected number. Additional bonusing opportunities may be provided as the patron continues to play; these subsequent opportunities may be offered after the patron exceeds an additional number of sessions in the given time period, or an extended time period.

Gaming machine number: The bonusing application may compare the patron's gaming machine number, or a portion thereof, with a preselected or randomly generated number (or set of numbers). The application may be configured to provide an instant bonusing opportunity if there is a numerical match.

Gaming machine type: The bonusing application may generate an instant bonus opportunity if the patron is playing at a certain type of gaming machine (for example, draw poker), or a gaming machine by a certain manufacturer, or a gaming machine having a certain bet amount (or a certain minimum bet amount), or other criteria relating to gaming machine type.

Bank: The bonusing application may generate an instant bonus opportunity based upon the bank or financial institution affiliated with the card or data carrier presented to the card/data reader located at the gaming machine.

Monetary denomination: The bonusing application may generate an instant bonus opportunity if the patron is playing a specified monetary denomination at a gaming machine (for example, draw poker).

Game type: The bonusing application may generate an instant bonus opportunity if the patron is playing a certain type of game at a gaming machine (for example, draw poker).

Location within the gaming establishment: For example, the bonusing application may be configured to generate an instant bonus opportunity for patrons playing in a high stakes area, or another particular area of the gaming establishment.

In any of the above examples, the bonusing application may be configured to provide an instant bonus opportunity in only a percentage of the possible instances, determined dynamically. For example, the bonusing application may be configured to provide an instant bonus opportunity 20% of the time when a patron has won or lost a predetermined amount (e.g., $100). Also, any mixture of the above instant bonus triggering events may be utilized, and each could possibly be given its own percentage change of occurring for each possible opportunity. For example, the bonusing application may be configured to provide an instant bonus opportunity 100% of the time if the current date is the patron's birthday, but only 25% of the time if the patron has been playing over a prespecified amount of time (e.g., 30 minutes). The bonusing application is preferably provided with an administrative interface, allowing the gaming establishment to adjust the criteria to be used for bonusing for each gaming machine, or groups of gaming machines, and, if desired, to adjust the percentages for each bonusing criterion.

The type of instant bonus opportunity may, although need not, depend upon the particular rule that was invoked to create the instant bonus opportunity. For instance, according to one possible embodiment, the bonusing application may be configured to present an instant bonus opportunity as follows:

Event based: If the instant bonus opportunity was generated from an event (such as, e.g., a birthday or anniversary), then the bonusing application may, for example, be configured to present a number of similar images or icons from which the patron may select in order to attempt to win a bonus prize. For instance, if the event is a birthday, the bonusing application may present a number of birthday cake images on the display screen of the player interface module. On the other hand, if the event is an anniversary, the bonusing application may present a number of giftbox images on the display screen of the player interface module. After the appropriate images are displayed, the patron may then select one of the images (e.g., by touching the image if the display screen is a touchscreen, or otherwise indicating the selection) and receive the prize revealed.

Play based: If the instant bonus opportunity was generated from gaming play (such as, e.g., exceeding a win/loss threshold or minimum coin-in/playing time threshold), then the bonusing application may be configured to present a number of similar images or icons (e.g., money bags, coins, dollar signs, etc.) from which the patron may select in order to attempt to win a bonus prize. After the images are displayed, the patron may then select one of the images (e.g., by touching the image if the display screen is a touchscreen, or otherwise indicating the selection) and receive the prize revealed.

Preference based: If the instant bonus opportunity was generated from a preference related criterion, such as machine or game type, then the bonusing application may be configured to provide an interactive bonusing opportunity along the lines of the patron's preference. For example, the bonusing application may be configured to deal the patron a hand of poker and provide a bonus based upon the hand dealt.

Holiday based: Similar to the event-based bonusing scheme, if the instant bonus opportunity was generated from a holiday event (such as, e.g., 4^{th} of July, Thanksgiving, Christmas, etc.), then the bonusing application may be configured to present a number of appropriate images or icons (e.g., fireworks, turkeys, Christmas trees, etc.) from which the patron may select in order to attempt to win a bonus prize. After the appropriate images are displayed, the patron may then select one of the images (e.g., by touching the image if the display screen is a touchscreen, or otherwise indicating the selection) and receive the prize revealed.

The above are merely illustrative examples. A wide variety of other types of instant bonusing opportunities may also be utilized, according to the preference of the gaming establishment.

Bonus prizes may take a variety of forms. For example, bonuses may be in the form of instant free-play credit, cash, players club points, promotional entries, or free or discounted amenities.

Once the patron's bonus prize is determined, it may be awarded to the patron in any of a variety of manners. For example, the central player control computer system (e.g., 152 in FIG. 1) may notify a floor host or other gaming establishment personnel, via radio link or otherwise, of the patron's name and/or gaming machine identifier. The patron can then be awarded the bonus prize in person. Alternatively, the central player control computer system may signal the vouchering system (see, e.g., U.S. application Ser. No. 09/858,157 filed May 14, 2001, hereby incorporated by reference as if set forth fully herein) and subsequently the gaming machine printer or local printer (e.g., 388 or 369 in FIG. 3) to print a cash voucher directly at the gaming machine 305. If the gaming machine does not have printing capability, the optional printer (e.g., printer 388) affixed to or associated with the gaming machine 305 may print a voucher for the patron. The prize may be in the form of cash, or voucher credit, or alternatively may be in the form of player points credited directly to the player's club account. The prize may also be in the form of a coupon that can be printed locally, or delivered to the patron, or else can be in the form of a discount redeemable at an affiliated establishment.

An advantage of a system architecture such as illustrated in FIG. 1 or 3 is that it provides the opportunity for bonus opportunities to be based on a broader spectrum of information than merely a specific player's coin in, time of play, or activity at a given machine. Rather, a rules engine for determining and generating instant bonus opportunities may draw upon as much of the information in the player database 170 as needed to ensure that players who contribute to the gaming establishment in a variety of ways are not overlooked. For example, some players may significantly utilize other services, such as hotels, restaurants, golf, entertainment, retail, etc., affiliated with the gaming establishment, and these activities can be taken into account by the rules engine. Each of these activities may be weighted according to pre-specified guidelines in order to determine the total worth of a player to the gaming establishment, and that information may be used by the rules engine, along with other information (such as current gaming activity), in determining whether an instant bonus opportunity should be generated. The rules engine may also invoke different guidelines depending upon the tier or status of a player, with certain bonus generation rules applicable to non-members, and other bonus generation rules applicable in varying degrees to players depending upon the tier or status within the players club.

While preferred embodiments have been described herein, many variations are possible which remain within the concept and scope of the invention. Such variations would become clear to one with ordinary skill in the art after her or she inspects the specification and the drawings. The invention, therefore, is not to be restricted except within the spirit and scope of any appended claims.

What is claimed is:

1. A gaming system, comprising:
a plurality of electronic gaming machines;
a central gaming system computer for monitoring said electronic gaming machines, said central gaming system computer communicating with said electronic gaming machines according to a gaming machine protocol;
an audit database coupled to said central gaming system computer; and
a plurality of player interface modules, each of said player interface modules physically proximate to one of said electronic gaming machines, said player interface modules coupled to a central player system computer and communicating therewith according to a protocol other than said gaming machine protocol.

2. The gaming system of claim 1, wherein at least one of said player interface modules is physically integrated with at least one of said electronic gaming machines.

3. The gaming system of claim 1, wherein at least one of said player interface modules is physically attached externally to at least one of said electronic gaming machines.

4. The gaming system of claim 3, wherein said at least one player interface module comprises a housing separate from an electronic gaming machine housing of said at least one electronic gaming machine, and wherein the housing of said at least one player interface module is physically attached to said at least one electronic gaming machine by an external arm projecting from the housing of said at least one electronic gaming machine.

5. The gaming system of claim 1, said player interface modules are housed independently of said electronic gaming machines, and wherein each of said player interface modules is physically attached externally to said electronic gaming machines.

6. The gaming system of claim 1, wherein one or more of said player interface modules comprise an interactive display.

7. The gaming system of claim 6, wherein said interactive display comprises a touchscreen.

8. The gaming system of claim 6, wherein said player interface modules provide two-way interactive communication between players at different electronic gaming machines.

9. The gaming system of claim 6, further comprising a remote gaming establishment computer coupled to said central player system computer and having an interactive communication interface, wherein said player interface modules provide two-way interactive communication between players and an operator of said remote gaming establishment computer.

10. The gaming system of claim 9, wherein said player interface modules present a plurality of gaming establishment service options to said players, whereby player selections of one or more of said gaming establishment service options results in a service request presented at said remote gaming establishment computer.

11. The gaming system of claim 9, wherein said player interface modules comprise a text entry interface allowing players to enter alphanumeric data.

12. The gaming system of claim 6, wherein said player interface modules provide audio two-way communication.

13. The gaming system of claim 1, wherein said central player system computer communicates with said central gaming system computer in order to track player activity.

14. The gaming system of claim 13, wherein said player interface modules provide bonus play activity for players at said electronic gaming machines.

15. The gaming system of claim 14, wherein said bonus play activity is influenced by interactive selections made by players at said electronic gaming machines, in response to options presented visually at said player interface modules.

16. The gaming system of claim 15, wherein said options are presented at said player interface modules based upon player data stored in a player tracking database coupled to said central player system computer.

17. The gaming system of claim 15, wherein bonus results are conveyed from said central player system computer to said central gaming system computer.

18. A player interface module adapted for use with an electronic gaming machine that is coupled to a central gaming system computer and communicates therewith according to a gaming machine protocol, said apparatus comprising:
a module housing physically proximate to said electronic gaming machine;
a display;
a controller;
a data entry device; and
a communication interface for communicating with a central player system computer according to a protocol different from said gaming machine protocol, whereby user selections input to said data entry device are conveyed to said central player system computer.

19. The player interface module of claim 18, wherein said display and said data entry device are integrated in the form of a touchscreen.

20. The player interface module of claim 18, further comprising an audio speaker and a microphone, whereby two-way audio communication is provided via said central player computer system.

21. The player interface module of claim 20, wherein two-way audio communication is provided with a second player interface module located at a second electronic gaming machine.

22. The player interface module of claim 20, wherein two-way audio communication is provided with a remote gaming establishment computer coupled to said central player computer system.

23. The player interface module of claim 20, wherein said display presents player options selectable via said data entry device.

24. The player interface module of claim 23, wherein said player options provide bonus play activity.

25. The player interface module of claim 24, wherein said bonus play activity is influenced in response to selection of said player options made manually via said data entry device.

26. The player interface module of claim 24, wherein said player options are chosen based in part upon player data stored in a player tracking database coupled to said central player system computer.

27. A method for controlling an electronic gaming system, comprising the steps of:
monitoring a plurality of electronic gaming machines via a central gaming system computer;
communicating between said central gaming system computer and said electronic gaming machines according to a gaming machine protocol;
storing gaming data in an audit database coupled to said central gaming system computer;
coupling a plurality of player interface modules to a central player system computer, each of said player interface modules physically proximate to one of said electronic gaming machines; and
communicating between said player interface modules and said central player system computer according to a protocol other than said gaming machine protocol.

28. The method of claim 27, wherein at least one of said player interface modules is physically integrated with at least one of said electronic gaming machines.

29. The method of claim 27, wherein at least one of said player interface modules is physically attached externally to at least one of said electronic gaming machines.

30. The method of claim 27, wherein one or more of said player interface modules comprise an interactive display.

31. The method of claim 30, wherein said interactive display comprises a touchscreen.

32. The method of claim 30, further comprising the step of providing two-way interactive communication between players at different electronic gaming machines via said player interface modules.

33. The method of claim 30, further comprising the steps of:
coupling a remote gaming establishment computer to said central player system computer, said remote gaming establishment computer having an interactive communication interface; and
providing two-way interactive communication between players interacting with said player interface modules and an operator of said remote gaming establishment computer utilizing said interactive communication interface.

34. The method of claim 33, further comprising the steps of:
presenting a plurality of gaming establishment service options to said players via said player interface modules;
receiving player selections of said gaming establishment service options; transmitting a service request to said remote gaming establishment computer in response to said player selections; and
displaying an indicia of said service request at the interactive communication interface of said remote gaming establishment computer.

35. The method of claim 27, further comprising the step of providing audio two-way communication via said player interface modules.

36. The method of claim 27, further comprising the step of communicating between said central player system computer and said central gaming system computer in order to track player activity at said central player system computer.

37. The method of claim 36, further comprising the step of providing bonus play activity for players at said electronic gaming machines via said player interface modules.

38. The method of claim 37, wherein said bonus play activity is influenced by interactive selections made by players at said electronic gaming machines, in response to options presented visually at said player interface modules.

39. The method of claim 38, further comprising the step of presenting said options at said player interface modules based upon player data stored in a player tracking database coupled to said central player system computer.

40. A method of configuring an electronic gaming unit, comprising the steps of:
coupling an electronic gaming machine to a central gaming system computer, said electronic gaming machine communicating with said central gaming system computer according to a gaming machine protocol;
locating a player interface module proximate to said electronic gaming machine, said player interface module comprising:
a module housing physically attached to or integrated with said electronic gaming machine;
a display;
a controller;
a data entry device; and
a communication interface;
receiving user selections via said data entry device; and
communicating between said player interface module, via said communication interface, and a central player system computer according to a protocol different from said gaming machine protocol.

41. The method of claim 40, wherein said display and said data entry device are integrated in the form of a touchscreen.

42. The method of claim 40, wherein said player interface module further comprises an audio speaker and a microphone, said method further comprising the step of providing two-way audio communication to a player utilizing said player interface module via said central player computer system.

43. The method of claim 42, wherein two-way audio communication is provided with a second player interface module located at a second electronic gaming machine.

44. The method of claim 42, wherein two-way audio communication is provided with a remote gaming establishment computer coupled to said central player computer system.

45. The method of claim 40, further comprising the step of presenting player options via said display, said player options being selectable via said data entry device.

46. The method of claim 45, wherein said player options provide bonus play activity.

47. The method of claim 46, wherein said bonus play activity is influenced in response to selection of said player options made manually via said data entry device.
